(19) United States
(12) Patent Application Publication
(10) Pub. No.: US 2008/0238293 A1
(43) Pub. Date: Oct. 2, 2008

(54) Self-Luminous Planar Display Device

(76) Inventors: Yuichi INOUE, Mobara (JP); Go Uchida, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/132,191

(22) Filed: Jun. 3, 2008

Related U.S. Application Data
(62) Division of application No. 11/211,437, filed on Aug. 26, 2005.

(30) Foreign Application Priority Data
Aug. 27, 2004 (JP) 2004-248692

(51) Int. Cl. H01J 63/04

(52) U.S. Cl. 313/496

(57) ABSTRACT

A self-luminous planar display device includes a back panel having first electrodes and second electrodes, a face panel with third electrodes on a face substrate, and a sealing frame. The first and second electrodes includes first and second electrode lead terminals pulled out to an outside, and a bent portion is formed on a portion of one of or both the first and second electrode lead terminals. Assuming a distance between the bent portion and the sealing frame as L1, a height of the sealing frame as H, and a distance between a periphery of the third electrode and the sealing frame as L2, a following relationship is established, 12 mm≦(L1+H+L2)≦38 mm.

### CROSS REFERENCE TO RELATED APPLICATION

This application is a divisional application of U.S. application Ser. No. 11/211,437, filed Aug. 26, 2005, the contents of which are incorporated herein by reference.

### BACKGROUND OF THE INVENTION

1. Field of the Invention

The present invention relates to a display device which makes use of the emission of electrons into a vacuum, and more preferably applicable to a self-luminous planar display device which includes a display panel formed by sealing a back panel having electron sources for emitting electrons and a face panel having phosphor layers of plurality of colors which emit lights when excited by electrons taken out from the back panel and electron accelerating electrodes using a sealing frame.

2. Description of the Related Art

A color cathode ray tube has been popularly used conventionally as an excellent display device which exhibits high brightness and high definition. However, along with the realization of high image quality of recent information processing device and television broadcasting, there has been a strong demand for a planar display device which is light-weighted and requires a small space for installation while ensuring the excellent properties such as high brightness and high definition.

As typical examples of such a planar display device, a liquid crystal display device, a plasma display device or the like has been put into practice. Further, particularly with respect to the planar display device which can realize the high brightness, various types of panel display devices including an electron emission type display device which makes use of emission of electrons into a vacuum from electron sources, a field emission type display device, and an organic EL display which is characterized by low power consumption are expected to be put into practice in near future. Here, the plasma display device, the electron emission type display device or the organic EL display device which requires no auxiliary illumination light sources is referred to as a self-luminous planar display device.

Among these self-luminous planar display devices, with respect to the electron emission type display device, the display device which has the cone-shaped electron emission structure proposed by C. A. Spindt, a display device which has the metal-insulator-metal (MIM) type electron emission structure, a display device which has the electron emission structure making use of an electron emission phenomenon based on a quantum tunneling effect (also referred to as surface conductive type electron sources), and a display device which makes use of an electron emission phenomenon which a diamond film, a graphite film, nanotubes or the like as represented by carbon nanotubes and the like have been known.

FIG. 9A and FIG. 9B are schematic views for explaining the constitution of an essential part of the self-luminous planar display device, wherein FIG. 9A is a cross-sectional view of an essential part and FIG. 9B is a plan view of an essential part in a state that a face panel is removed from the constitution shown in FIG. 9A. The self-luminous planar display device is constituted by integrally forming a back panel PNL1 and a face panel PNL2 using a sealing frame MFL. On an inner surface of a back substrate SUB1 which constitutes the back panel PNL1, a large number of first electrodes (hereinafter referred to as data lines) D which extends in the first direction (hereinafter referred to as y direction) and are arranged in parallel in the second direction (hereinafter referred to as x direction) which intersects the first direction, an interlayer insulation film NS which is formed so as to cover the data lines D, and a large number of second electrodes (hereinafter referred to as scanning lines) S which extend in the x direction and are arranged in parallel in the y direction on the interlayer insulation film NS are formed. Further, electron sources not shown in the drawing are formed on intersecting portions of the data lines D and the scanning lines S or in the vicinity of these intersecting portions thus constituting a display region.

On the other hand, on an inner surface of a face substrate SUB2 which constitutes the face panel PNL2, a phosphor layers PH which emit lights of plurality of colors and an anode AD which constitutes a third electrode are formed. Here, it is desirable to provide a light blocking layer between the respective phosphor layers PH. Further, the face panel PNL2 is laminated to the back panel PNL1 using the sealing frame MFL and the inside of a space defined by these members is evacuated into a vacuum.

Electron sources are provided in the vicinity of the intersecting portions between the data lines D and the scanning lines S and an electron emission quantity (including turning on and off of the emission) is controlled based on the potential difference between the data line D and the scanning line S. The emitted electrons are accelerated by a high voltage applied to the anode AD formed on the face panel PNL2 and impinge on phosphor layers formed on the face panel PNL2 so as to excite the phosphor layers whereby the phosphor layers emit lights of colors which correspond to the light emitting properties of the phosphor layers.

Further, the sealing frame MFL is interposed between the back panel PNL1 and the face panel PNL2 and is fixed to inner peripheries of the back panel PNL1 and the face panel PNL2 using an adhesive material such as frit glass. The degree of vacuum in the inside defined by the back panel PNL1, the face panel PNL2 and the sealing frame MFL is set to, for example, 10⁻³ to 10⁻⁷, for example. With respect to the self-luminous planar display device having a large display screen size, gap holding members (partition walls or spacers) are interposed and fixed between the back panel and the face panel so as to hold the gap therebetween to a given distance.

Between the sealing frame MFL and the back panel PNL1, data line lead terminals which are connected with the data lines D formed on the back substrate PNL1 and scanning line lead terminals ST which are connected with the scanning lines S are present. Usually, the sealing frame MFL is fixed to the back panel PNL1 and the face panel PNL2 using the adhesive agent such as frit glass. The scanning line lead terminals ST and the data line lead terminals are pulled out through the adhesive portion which adheres the sealing frame MFL and the back panel PNL1. Techniques relevant to this type of display device are disclosed in JP-A-9-199065 (patent literature 1) and JP-A-2000-251778 (patent literature 2).

### SUMMARY OF THE INVENTION

The data lines D formed on the back panel PNL1 are pulled out to the outside of the sealing frame MFL using the data line lead terminals. In the same manner, the scanning lines S are pulled out to the outside of the sealing frame MFL using the scanning line lead terminals ST. These lead terminals are usually connected to terminals of drive circuit chips which are mounted on an outer peripheral portion of the back panel PNL1. Although only the scanning lines S and the scanning line lead terminals ST are described in the explanation made hereinafter, the same substantially goes for the data lines and the data line lead terminals. That is, the scanning line lead terminals ST are connected to the terminals of the scanning line drive circuit chip SDR. A plurality of scanning line drive circuit chips SDR are mounted and one scanning line drive circuit chip SDR supplies signals to a plurality of electrode lead terminals. An interval of terminals of the scanning line drive circuit chip SDR is narrower than a distance of the scanning lines S. Accordingly, to allow a plurality of scanning line lead terminals ST which are connected to each scanning line drive circuit chip SDR to be converged toward the terminal of the corresponding scanning line drive circuit chip SDR, bent portions are formed in the vicinity of the inside of the sealing frame MFL.

When such bent portions are formed, a wide gap Q is formed between the bent portion and another bent portion of the lead terminal which is connected to the neighboring scanning line drive circuit chip SDR and hence, a surface of an interlayer insulation film NS or the back substrate SUB1 is exposed. Since the exposed portion has no conductivity, the exposed portion is charged or electrified during the operation. This electrified charge becomes a cause of creeping discharge which generates discharge along a surface of the sealing frame MFL between the anode AD to which a high voltage is applied and the sealing frame MFL. This discharge deteriorates the display quality of the display device and, in an extreme case, brings about the breaking of the display device thus lowering the reliability.

It is an object of the present invention to provide a self-luminous planar display device which exhibits high quality and high reliability by suppressing the discharge attributed to the electrification of charges in a gap formed in bent portions of electrode lead terminals.

To achieve the above-mentioned object, according to a first aspect of the present invention, there is provided lead terminals having the constitution in which an exposed portion on an insulation layer or a substrate surface which is generated by the bent portions of the electrode lead terminals is not present in the inside of a sealing frame.

Further, according to a second aspect of the present invention, even when the exposed portion attributed to the bent portions of the lead terminals is present in the inside of the sealing frame, a creeping distance from the exposed portion to an anode is set to a size which exceeds a discharge voltage generated value due to a potential difference between the electrode lead terminal and the anode.

Further, according to a third aspect of the present invention, an electrode width of the bent portion of the lead terminal is increased thus allowing the bent portion to cover a most portion of the exposed insulation layer or the substrate surface.

That is, the self-luminous planar display device according to the present invention includes: a back panel which forms a display region having a large number of pixels on a back substrate, the pixels including a large number of first electrodes which extend in the first direction (y direction) and are arranged in parallel in the second direction (x direction) which intersects the first direction, an interlayer insulation film which is formed to cover the first electrodes, a large number of second electrodes which extend in the second direction (x direction) and are arranged in parallel in the first direction (y direction) over the interlayer insulation film, and electron sources which are formed in the vicinity of intersecting portions between the first electrodes and the second electrodes; a face panel which forms phosphor layers of plural colors which emit lights when excited by electrons taken out from the electron sources formed on the display region of the back panel and third electrodes on a face substrate; and a sealing frame which is interposed between peripheral portions of the back panel and the face panel and seals both panels.

Here, the present invention is characterized in that at least one end of the first electrode includes a first electrode lead terminal which is pulled out to the outside from the display region through a sealing region where the back panel and the sealing frame face in an opposed manner,

at least one end of the second electrode includes a second electrode lead terminal which is pulled out to the outside from the display region through a sealing region where the back panel and the sealing frame face in an opposed manner, and

one or both of the first electrode lead terminal and the second electrode lead terminal are arranged parallel to each other at least to the inside of the sealing frame.

Further, the self-luminous planar display device according to the present invention is also characterized in that

at least one end of the first electrode includes a first electrode lead terminal which is pulled out to the outside from the display region through a sealing region where the back panel and the sealing frame face in an opposed manner,

at least one end of the second electrode includes a second electrode lead terminal which is pulled out to the outside from the display region through a sealing region where the back panel and the sealing frame face in an opposed manner, and

a bent portion for pulling out the lead terminal toward an exteriorly mounted drive circuit is formed on a portion of one or both of the first electrode lead terminal and the second electrode lead terminal in the vicinity of the inside of the sealing frame, and an exposed portion is formed on a surface of the interlayer insulation film or the back substrate by forming the bent portion, and

assuming a distance between the bent portion and the sealing frame as L1, a height of the sealing frame as H, and a distance between a periphery of the third electrode and the sealing frame as L2, a following relationship is established.

12 mm≦(L1+H+L2)≦38 mm

Further, the self-luminous planar display device according to the present invention is also characterized in that

at least one end of the first electrode includes a first electrode lead terminal which is pulled out to the outside from the display region through a sealing region where the back panel and the sealing frame face in an opposed manner,

at least one end of the second electrode includes a second electrode lead terminal which is pulled out to the outside from the display region through a sealing region where the back panel and the sealing frame face in an opposed manner, and

a bent portion for pulling out the lead terminal toward an exteriorly mounted drive circuit is formed on a portion of one of or both the first electrode lead terminal and the second electrode lead terminal in the vicinity of the inside of the sealing frame, and on an exposed portion which is formed on a surface of the interlayer insulation film or the back substrate formed due to the formation of the bent portion, an enlarged electrode portion which enlarges an area of one of or both the first electrode lead terminal and the second electrode lead terminal is formed.

According to the present invention, it is possible to provide a self-luminous planar display device which can enhance the reliability by suppressing discharge generated along a surface of a sealing frame. Further, since the dielectric resistance is also enhanced, it is possible to obtain the high-brightness display by increasing an anode voltage.

### BRIEF DESCRIPTION OF THE DRAWINGS

FIG. 1A and FIG. 1B are schematic views for explaining an embodiment 1 of a self-luminous planar display device according to the present invention;

FIG. 2A and FIG. 2B are schematic views of an essential part for explaining an embodiment 2 of a self-luminous planar display device according to the present invention and similar to FIG. 1;

FIG. 3 is a plan view of an essential part for explaining an embodiment 3 of a self-luminous planar display device according to the present invention and similar to FIG. 1B;

FIG. 4 is a schematic plan view for explaining the whole constitution of a self-luminous planar display device according to the present invention;

FIG. 5A to FIG. 5C are views for explaining an example of an electron source in FIG. 4;

FIG. 6 is an explanatory view of an example of an equivalent circuit of a self-luminous planar display device according to the present invention;

FIG. 7 is a perspective view showing the entire structure of a self-luminous planar display device according to the present invention;

FIG. 8 is a cross-sectional view taken along a line D-D′ in FIG. 7;

FIG. 9A and FIG. 9B are schematic views for explaining the constitution of an essential part of a self-luminous planar display device; and

FIG. 10 shows a result obtained by measuring a creeping discharge generating voltage Vs (kV) of the sealing frame when a value of (L1+H+L2)(mm) is changed.

### DESCRIPTION OF THE PREFERRED EMBODIMENTS

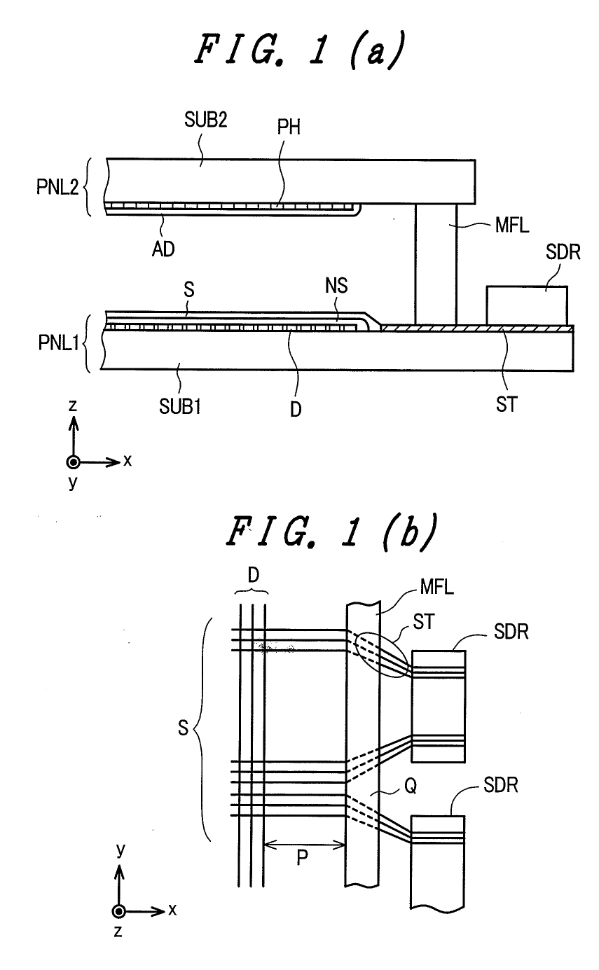

Embodiments of the present invention are explained in detail in conjunction with attached drawings hereinafter. First of all, an embodiment 1 of the present invention is explained in conjunction with FIG. 1A and FIG. 1B.

### Embodiment 1

FIG. 1A and FIG. 1B are schematic views for explaining an embodiment 1 of a self-luminous planar display device according to the present invention, wherein FIG. 1A is a cross-sectional view of an essential part and FIG. 1B is a plan view of an essential part in a state that a face panel is removed from the display device shown in FIG. 1A.

In the self-luminous planar display device, a back panel PNL1 and a face panel PNL2 are integrally formed using a sealing frame MFL. On an inner surface of the back panel PNL1, a large number of first electrodes (hereinafter referred to as data lines) D which extends in the first direction (hereinafter referred to as y direction) and are arranged in parallel in the second direction (hereinafter referred to as x direction) which intersects the first direction, an interlayer insulation film NS which is formed so as to cover the data lines D, and a large number of second electrodes (hereinafter referred to as scanning lines) S which extend in the x direction and are arranged in parallel in the y direction on the interlayer insulation film NS are formed. Further, electron sources not shown in the drawing are formed on intersecting portions of the data lines D and the scanning lines S or in the vicinity of these intersecting portions.

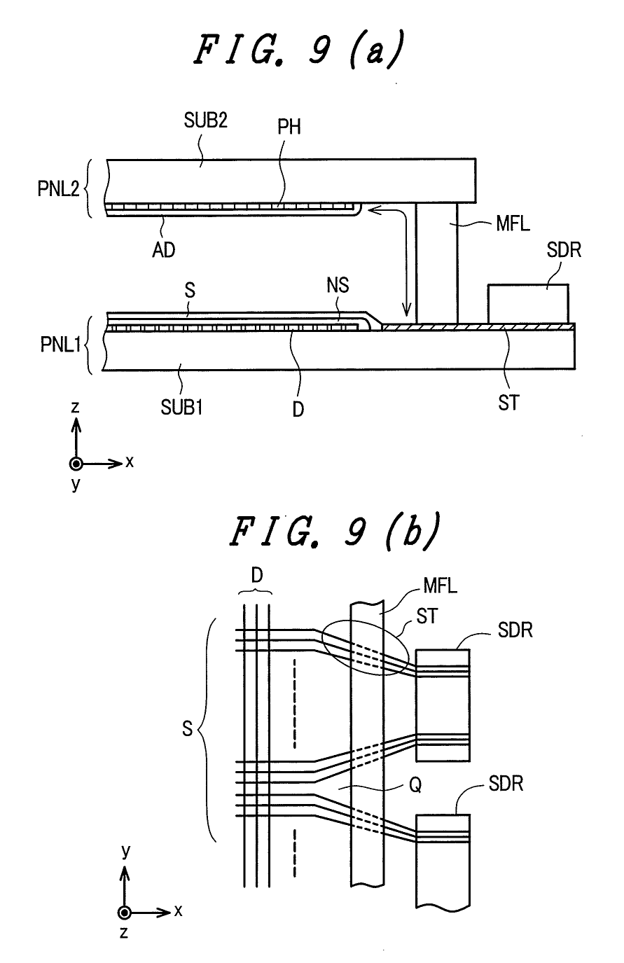

On the other hand, on an inner surface of the face panel PNL2, a phosphor layers PH which emit lights of plurality of colors and an anode AD which constitutes a third electrode are formed. Here, it is desirable to provide a light blocking layer (so-called black matrix) between the respective phosphor layers PH. Further, the face panel PNL2 is laminated to the back panel PNL1 using the sealing frame MFL and the inside of a space defined by these members is evacuated into a vacuum. Since the constitution except for the constitutional features of the embodiment 1 is substantially equal to the constitution shown in FIG. 9, the repeated explanation is omitted.

The self-luminous planar display device of embodiment 1 includes the back panel PNL1 which forms a display region having a large number of pixels which include a large number of data lines D which extend in the y direction and are arranged in parallel in the x direction which intersects the y direction, the interlayer insulation film NS which is formed to cover the data lines D, a large number of scanning lines S which extend in the x direction and are arranged in parallel in the y direction on the interlayer insulation film NS, and electron sources (not shown in the drawing) which are provided on the intersecting portions between the data lines D and the scanning lines S or in the vicinity of the intersecting portions on the back substrate SUB1, the face panel PNL2 which forms the phosphor layers PH of plurality of colors which emit light when excited by electrons taken out from the above-mentioned electron sources formed on the display region of the back panel PNL1 and an anode AD which constitutes a third electrode on the face substrate SUB1, and the sealing frame MFL which is interposed between peripheral portions of the back panel PNL1 and the face panel PNL2 and seals both panels.

Further, the embodiment 1 includes data line lead terminals (not shown in the drawing) which are pulled out to the outside from the display region through a sealing region (adhering region) where the back panel PNL1 and the sealing frame MFL face each other and are connected to terminals of a data line drive circuit chip (not shown in the drawing) on at least one end of the data lines D. Further, at least one end of the scanning lines S include scanning line lead terminals ST which are pulled out to the outside from the display region through the sealing region (adhering region) where the back panel PNL1 and the sealing frame MFL face each other and are connected to terminals of a scanning line drive circuit SDR.

The constitutional feature of the embodiment 1 lies in that one of or both the data line lead terminals and the scanning line lead terminals ST are formed such that the terminals are formed in parallel at least to the inside of the sealing frame MFL, and a gap Q which is formed by bent portions of the lead terminals which are connected to the neighboring data line drive circuit chips or scanning line drive circuit chips SDR is allowed to be present at positions where the gap Q does not project to the inside from the sealing region (adhering region) of the back panel PNL1 and the sealing frame MFL. Here, although only the scanning line lead terminals ST are illustrated in FIG. 1, the same goes for the data line lead terminals.

Due to the embodiment 1, even when the bent portion is formed with respect to one of or both the data line lead terminals and the scanning line lead terminals, there is no possibility that an interlayer insulation film or a back substrate is largely exposed in the vicinity of the inside of the sealing frame MFL and hence, the charging during the operation can be suppressed and the occurrence of discharge along the surface of the sealing frame between the lead terminals and the anode can be prevented.

### Embodiment 2

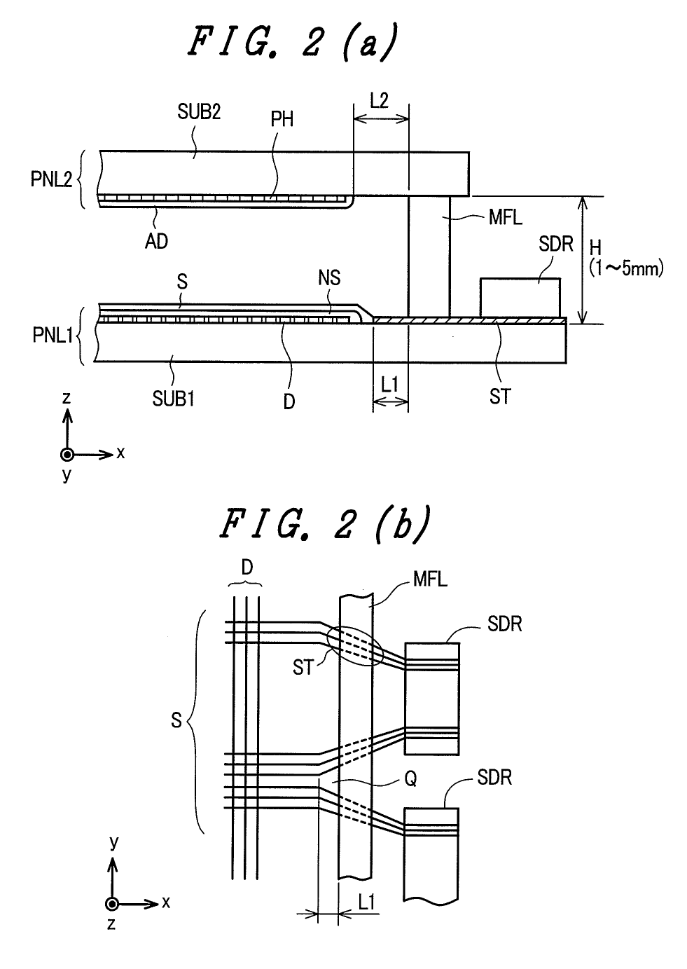

FIG. 2A and FIG. 2B are drawings similar to FIG. 1 and schematic views showing an essential part for explaining an embodiment 2 of the self-luminous planar display device of the present invention. Although the explanation is made with respect to the scanning line lead terminals ST in the embodiment 2, the embodiment is also applicable to the data line lead terminals. In the embodiment 2, even when the gap Q which is formed by the bending portion is present inside the sealing frame MFL, by determining the total (creeping distance) of a distance from the bent position of the lead terminals to the inside of the sealing frame MFL (a width of the gap Q), the height of the sealing frame MFL, and the distance from the inside of the sealing frame MFL to the end of the anode AD, it is possible to prevent the generation of discharge between the anode and the lead terminals along the surface of the sealing frame.

That is, assuming a dielectric strength limit value of the sealing frame MFL as 15 kV, the distance between a starting portion of the bent portion of either or both the data line lead terminals and/or the scanning line lead terminals ST and the sealing frame MFL as L1, a height of the sealing frame MFL as H, and a distance between a periphery of the anode AD and the sealing frame MFL as L2, the creeping distance is set as follows

12 mm≦(L1+H+L2)≦38 mm

This set range is based on data shown in FIG. 10. That is, FIG. 10 shows a result obtained by measuring a creeping discharge generating voltage Vs (kV) of the sealing frame when (L1+H+L2) (mm) is changed.

In general, the dielectric strength limit of the sealing frame having the height of 1 to 5 mm is 15 kV. In FIG. 10, in increasing the value of (L1+H+L2), when the value exceeds approximately 38 mm, the dielectric property of the sealing frame becomes dominant. Accordingly, to take the operation within the dielectric strength limit of the sealing frame into consideration, it is necessary to set the creeping distance (L1+H+L2) from the bent position of the lead terminals to the end of anode via an inner surface of the sealing frame to 38 mm or less. Further, an anode voltage adopted by the self-luminous planar display device is not less than 3 kV or not more than 10 kV and hence, it is desirable to adopt 12 to 27 mm as the value of (L1+H+L2) corresponding to the distance (a-b) in FIG. 10.

With the constitution described in the embodiment 2, it is also possible to prevent the occurrence of discharge between the anode and the lead terminals along the surface of the sealing frame of the back panel.

### Embodiment 3

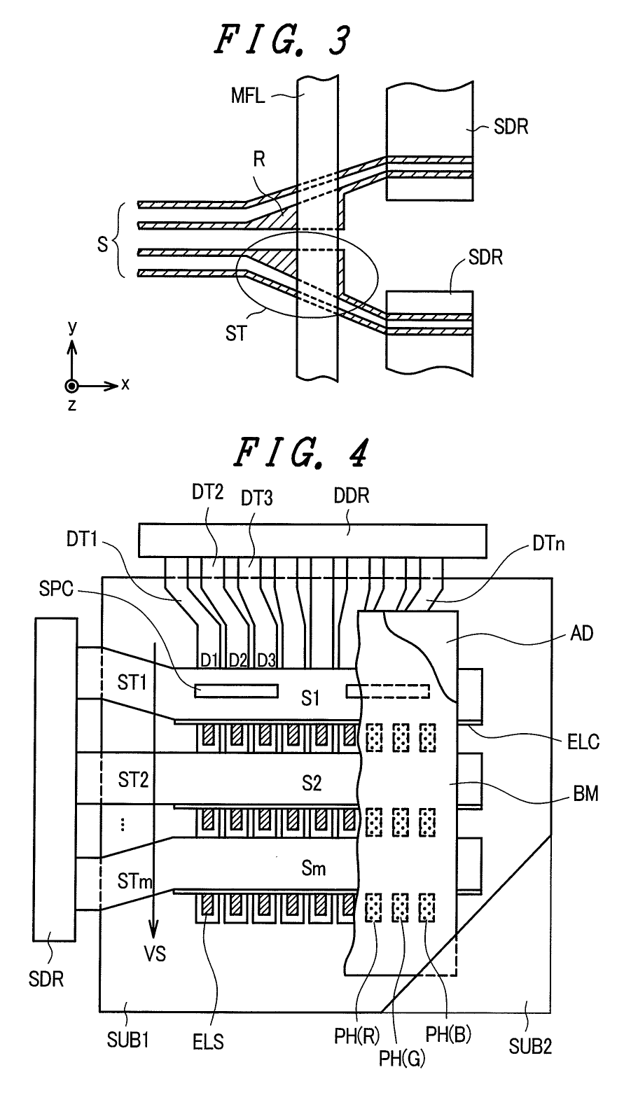

FIG. 3 is a view similar to FIG. 1B for explaining an embodiment 3 of the self-luminous planar display device and also is a plan view of an essential part. The embodiment 3 is characterize in that with respect to a portion of either or both the data line lead terminals and/or the scanning line lead terminals ST, in the vicinity of the inside of the sealing frame MFL, an enlarged electrode portion R is formed on the bent portion to pull out the lead terminals toward an exteriorly mounted drive circuit. The enlarged electrode portion R covers a gap (portion indicated by symbol Q in the above-mentioned embodiment) which is formed attributed to the formation of the bent portion and hence, the charging area is reduced. It is needless to say that a shape of the enlarged electrode portion R is not limited to the illustrated shape.

Also with the constitution of the embodiment 3, it is possible to prevent the occurrence of discharge between the anode and the lead terminals along the surface of the sealing frame from the back panel.

FIG. 4 is a schematic plan view for explaining the entire constitution of self-luminous planar display device according to the present invention. On the inner surface of the back substrate SUB1 which constitutes the back panel, the data lines D (D1, D2, D3, . . . Dn) are formed, and the scanning lines S (S1, S2, . . . Sm) are formed over the data lines D (D1, D2, D3, . . . Dn) in an intersecting manner by way of an insulation film (not shown in the drawing). Partition walls SPC are formed on some scanning lines S for holding a distance between the back panel and the face panel. The electron sources ELS are provided in the vicinity of intersecting portions between the data lines D and the scanning lines S and electricity is supplied to the electron sources ELS from the scanning lines S (S1, S2, . . . Sm) using connection electrodes ELC.

The anode AD is formed on the inner surface of the face substrate SUB2 which constitutes the face panel, wherein phosphor layers PH of three colors (PH (R), PH (G), PH (B)) are formed over the anode AD. In this constitution, the phosphors PH (PH(R), PH (G), PH (B)) are partitioned by a light blocking layer (black matrix BM). Here, although the anode electrode AD is shown as a matted electrode, it is possible to form the anode electrode AD in a stripe shape electrode which is divided for every pixel columns which intersect the scanning lines S (S1, S2, . . . Sm). Electrons which are irradiated from the electron sources ELS are accelerated and are allowed to impinge on the phosphor layers PH (PH(R), PH(G), PH(B)) which constitute corresponding sub pixels. Due to such constitution, the phosphor layer PH emits light of given color and the emitted light color is mixed with the emitted light color of phosphors of another sub pixels thus constituting the color pixel of given color.

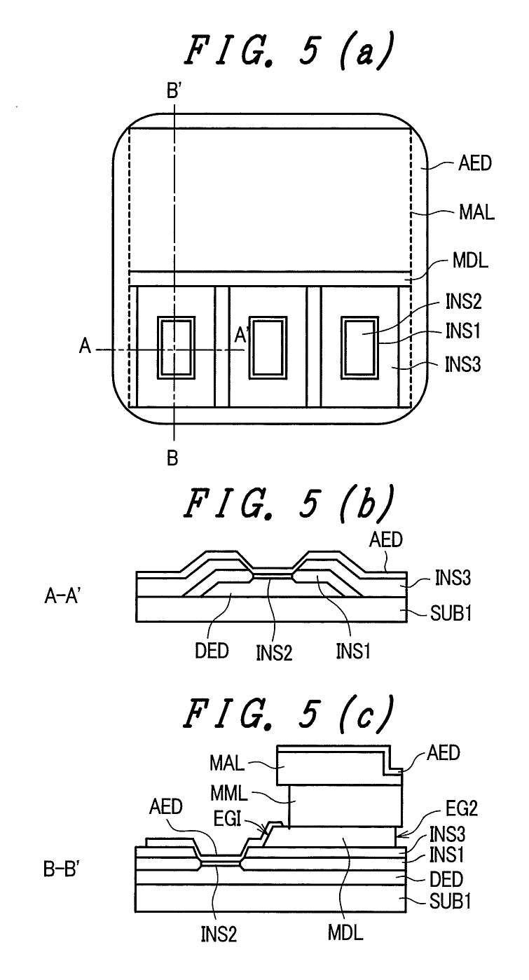

FIG. 5A, FIG. 5B and FIG. 5C are views for explaining one example of electron source in FIG. 4, wherein FIG. 5A is a plan view, FIG. 5B is a cross-sectional view taken along a line A-A′ in FIG. 5A, and FIG. 5C is a cross-sectional view taken along a line B-B′ in FIG. 5A. Here, the electron source is formed of an MIM electron source.

The structure of the electron source is explained in conjunction with the manufacturing steps thereof. First of all, on the back substrate SUB1, a lower electrode DED, a protective insulating layer INS1 and an insulating layer INS2 are formed. Next, an interlayer insulation film INS3 and metal films which form an upper bus electrode constituting a current supply line to an upper electrode AED and a spacer electrode for arranging a spacer are formed by a sputtering method or the like, for example. The interlayer insulation film INS3 may be made of silicon oxide, silicon nitride or silicon, for example. Here, silicon nitride is used as the material of the interlayer insulation film INS3 and a thickness of the interlayer insulation film INS3 is set to 100 nm. The interlayer insulation film INS3, when a pin hole is formed in the protective insulating layer INS1 which is formed by anodizing, embeds a cavity and plays a role of keeping the insulation between the lower electrode DED and the upper bus electrode (a three-layered stacked film which sandwiches copper (Cu) forming a metal-film intermediate layer MML between a metal-film lower layer MDL and a metal-film upper layer MAL) which constitutes the scanning line.

Here, the upper bus electrode which constitutes the scanning line is not limited to the above-mentioned three-layered stacked film and the number of layers can be increased more than three layers. For example, as the metal-film lower layer MDL and the metal-film upper layer MAL, a film made of a metal material having high oxidation resistance such as aluminum (Al), chromium (Cr), tungsten (W), molybdenum (Mo) or the like, an alloy of these material or a stacked film made of these materials can be used. Here, in this embodiment, an aluminum-neodymium (Al—Nd) alloy is used as the metal-film lower layer MDL and the metal-film upper layer MAL. Besides these materials, with the use of a five-layered film which uses a stacked film formed of an Al alloy film and a Cr film, a W film, a Mo film as the metal-film upper layer MAL, a stacked film formed of a Cr film, a W film, a Mo film and an Al alloy film as the metal-film lower layer MDL and uses high-melting-point metal as a film which is brought into contact with Cu in the metal-film intermediate layer MML, during the heating step in the manufacturing process of the image display device, the high-melting-point metal forms a barrier film so that the alloying of Al and Cu can be suppressed and this suppression of alloying is particularly effective in reducing the resistance of the wiring.

When only the Al—Nd alloy film is used as the above-mentioned metal-film lower layer MDL or metal-film upper layer MAL, with respect to a film thickness of the Al—Nd alloy film, a thickness of the metal-film upper layer MAL is set larger than a thickness of the metal-film lower layer MDL, while a thickness of the Cu film which constitutes the metal-film intermediate layer MML is increased as much as possible to reduce the wiring resistance. Here, the film thickness of the metal-film lower layer MDL is set to 300 nm, the film thickness of the metal-film intermediate layer MML is set to 4 μm, and the film thickness of the metal-film upper layer MAL is set to 450 nm. Here, the Cu film which constitutes the metal-film intermediate layer MML can be formed by electroplating besides sputtering.

In forming the above-mentioned five-layered film using the high-melting-point metal, in the same manner as the Cu film, it is particularly effective to use a stacked film which sandwiches the Cu film with Mo films which can be etched by wet etching using a mixed aqueous solution of phosphoric acid, acetic acid and nitric acid as the metal film intermediate layer MML. In this case, a film thickness of the Mo films which sandwich the Cu film is set to 50 nm, a film thickness of the Al alloy film which forms the metal-film lower layer MDL for sandwiching the metal-film intermediate layer is set to 300 nm, and a film thickness of the Al alloy film which forms the metal-film upper layer MAL for sandwiching the metal-film intermediate layer is set to 450 nm.

Subsequently, due to the patterning of resist by screen printing and etching, the metal-film upper layer MAL is formed in a stripe shape which intersects the lower electrodes DED. The etching is performed by wet etching using a mixed aqueous solution of, for example, phosphoric acid and acetic acid. Since the etchant does not contain nitric acid, it is possible to selectively etch only the Al—Nd alloy film without etching the Cu film.

Also in forming the five-layered film using Mo, using the etchant which does not contain nitric acid, it is possible to selectively etch only the Al—Nd alloy film without etching the Mo film and the Cu film. Here, although one metal-film upper layer MAL is formed per one pixel, it is also possible to form two metal-film upper layers MAL per one pixel.

Subsequently, using the same resist film as it is or using the Al—Nd alloy film on the metal-film upper layer MAL as a mask, the Cu film of the metal-film intermediate layer MML is etched by wet etching using a mixed aqueous solution of phosphoric acid, acetic acid and nitric acid. Since an etching rate of Cu in the mixed aqueous solution of phosphoric acid, acetic acid and nitric acid is sufficiently fast compared to an etching rate of the Al—Nd alloy film, it is possible to selectively etch only the Cu film of the metal-film intermediate layer MML. Also in forming the five-layered film using Mo, since etching rates of Mo and Cu are sufficiently fast compared to the etching rate of the Al—Nd alloy film, it is possible to selectively etch only the three-layered stacked film formed of the Mo films and the Cu film. In etching the Cu film, an ammonium persulfate aqueous solution and a sodium persulfate aqueous solution are effectively used besides the above-mentioned aqueous solution.

Subsequently, due to the patterning of resist by screen printing and etching, the metal-film lower layer MDL is formed in a stripe shape which intersects the lower electrodes DED. The etching is performed by wet etching using a mixed aqueous solution of phosphoric acid and acetic acid. Here, by shifting the printing resist film from the position of the stripe electrodes of the metal-film upper layer MAL, one-side end portion EG1 of the metal-film lower layer MDL is allowed to project from the metal-film upper layer MAL thus forming a contact portion which ensures the connection with the upper electrode AED in a later step. Further, to another-side end portion EG2 opposite to one-side end portion EG1 of the metal-film lower layer MDL, over-etching is performed using the metal-film upper layer MAL and the metal-film intermediate layer MML as a mask and a retracted portion is formed such that an eaves is formed on the metal-film intermediate layer MML.

Using the eaves of the metal-film intermediate layer MML, the upper electrode AED formed in the later stage is separated. Here, since a thickness of the metal-film upper layer MAL is larger than a thickness of the metal-film lower layer MDL, even when the etching of the metal-film lower layer MDL is finished, it is possible to leave the metal-film upper layer MAL on the Cu film of the metal-film intermediate layer MML. Accordingly, it is possible to protect the surface of the Cu film. Accordingly, even when Cu is used, it is possible to ensure the oxidation resistance, the upper electrode AED can be separated in a self-aligning manner, and it is possible to form the upper bus electrode which constitutes the scanning line which performs the supply of an electric current. Further, with respect to the five-layered metal-film intermediate layer MML which sandwiches the Cu film with molybdenum films, even when the Al alloy film of the metal-film upper layer MAL is thin, Mo suppresses the oxidation of Cu and hence, it is not always necessary to set the film thickness of the metal-film upper layer MAL larger than the film thickness of the metal-film lower layer MDL.

Subsequently, the interlayer film INS3 is formed to open an electron emitting portion. The electron emitting portion is formed in a portion of an intersecting portion of a space which is sandwiched between one lower electrode DED in the inside of the pixel and two upper bus electrodes (the stacked film formed of the metal-film lower layer MDL, the metal-film intermediate layer MML and the metal-film upper layer MAL and the stacked film formed of the metal-film lower layer MDL, the metal-film intermediate layer MML and the metal-film upper layer MAL of the neighboring pixel not shown in the drawing) which intersect the lower electrode DED. The etching can be performed by dry etching which uses an etchant gas containing CF₄ and SF₆, for example, as main components.

Finally, the upper electrode AED is formed as a film. In forming the upper electrode AED, a sputtering method is used. As the upper electrode AED, a stacked film formed of, for example, an iridium (Ir) film, a platinum (Pt) film and a gold (Au) film is used, wherein a film thickness is set to 6 nm. Here, in the upper electrode AED, one end portion (the right side in FIG. 5C) of the upper bus electrode (the stacked film formed of the metal-film lower layer MDL, the metal-film intermediate layer MML, the metal-film upper layer MAL) is cut at the retracting portion (EG2) of the metal-film lower layer MDL formed by the eaves structure of the metal-film intermediate layer MML and the metal-film upper layer MAL. Then, at another end portion (the left side in FIG. 5C) of the upper bus electrode, the upper electrode AED is continuously formed with the upper bus electrode (the stacked film formed of the metal-film lower layer MDL, the metal-film intermediate layer MML, the metal-film upper layer MAL) by way of the contact portion (EG1) of the metal-film lower layer MDL without breaking thus allowing the supply of electric current to the electron emitting portion.

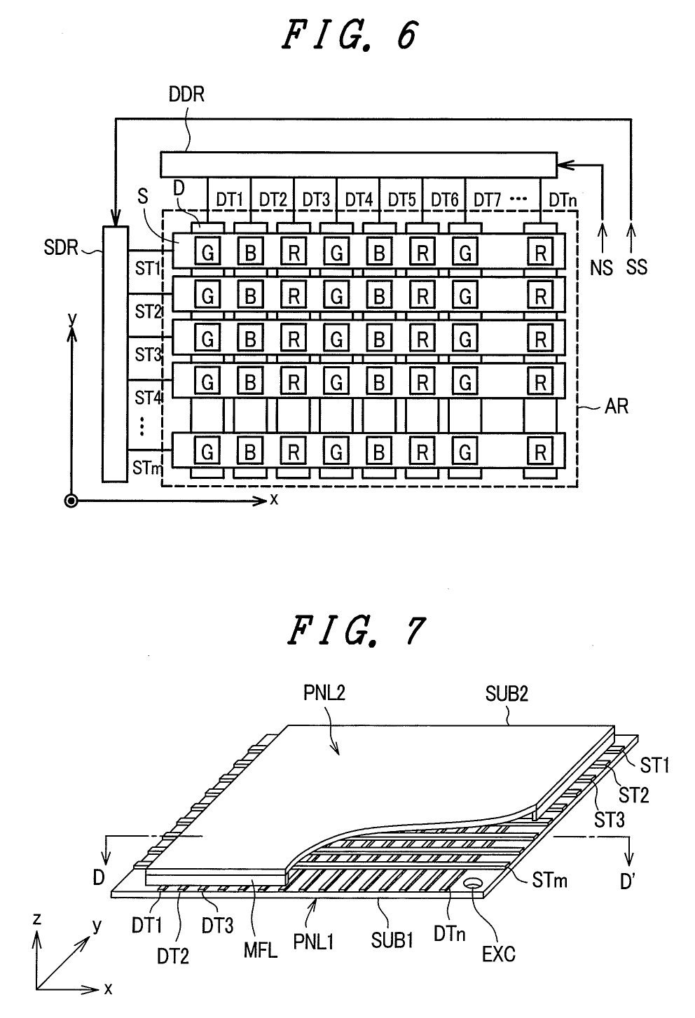

FIG. 6 is an explanatory view of an example of an equivalent circuit of the self-luminous planar display device of the present invention.

A region depicted by a broken line in FIG. 6 indicates a display region AR. In the display region AR, a plurality of data lines D and a plurality of scanning lines S are arranged in a state that these lines intersect each other thus forming pixels which are arranged in a matrix array of n×m. Sub pixels having colors are formed on the respective intersecting portions of the matrix and one group consisting of “R”, “G”, “B” in the drawing constitutes one color pixel. Here, the illustration of the constitution of the electron sources is omitted. The data lines D are connected to the data line drive circuit DDR through data line lead terminals DT (DT1 to DTn), while the scanning lines S are connected to the scanning line drive circuit SDR by way of the scanning line lead terminals (ST1 to STm). The image signal NS is inputted to the data line drive circuit DDR from an external signal source, while the scanning signal SS is inputted to the scanning line drive circuit SDR in the same manner.

Due to such a constitution, by supplying the image data to the sub pixels which are connected to the scanning lines S which are sequentially selected from the data lines D, it is possible to display a two-dimensional full color image. According to the display device of this constitutional example, a self-luminous planar display device which is operated at a relatively low voltage with high efficiency can be realized.

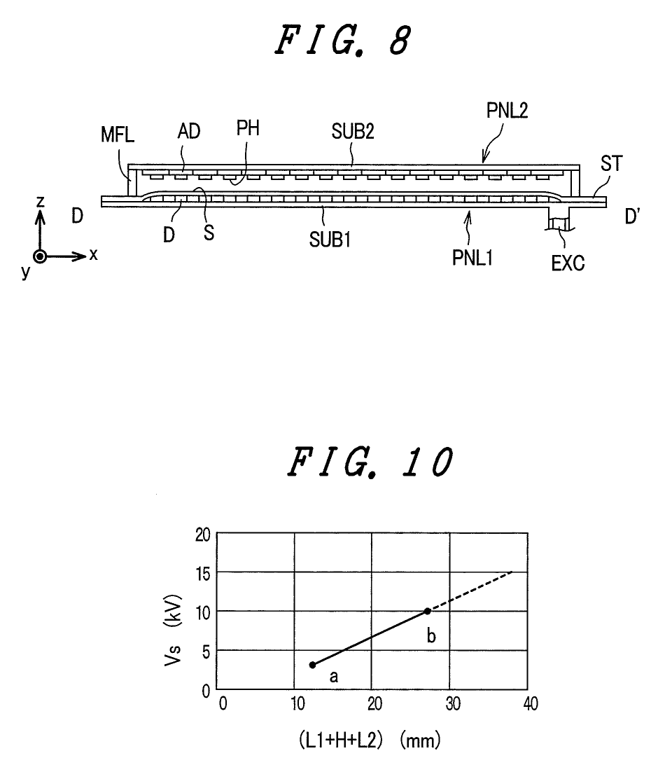

FIG. 7 is a perspective view showing the entire structure of the self-luminous planar display device according to the present invention, and FIG. 8 is a cross-sectional view taken along a line D-D′ in FIG. 7. The back panel PNL1 has, as has been explained in the above-mentioned embodiment, the electron source structure which is constituted of the matrix formed of the data lines D and the scanning lines S in the inner surface of the back substrate SUB1. On the other hand, the face panel pNL2 uses a transparent glass substrate as the face substrate SUB2 and the anode AD and the phosphor layers PH are formed on the inner surface thereof as films. An aluminum layer is used as the anode AD.

The face panel PNL2 and the back panel PNL1 are arranged to face each other and, for ensuring a given distance between facing surfaces of the face panel PNL2 and the back panel PNL1, the rib-like spacers (partition walls, not shown in the drawing) having a width of approximately 80 μm and a height of approximately 2.5 mm are fixed onto the scanning lines S along the extending direction of the scanning lines S while interposing frit glass therebetween. Here, a sealing frame MFL made of glass is arranged on peripheral portions of both panels and both panels and the sealing frame are fixed to each other using frit glass not shown in the drawing so as to provide the structure in which an inner space sandwiched by both panels is isolated from the outside.

In fixing the spacers using the frit glass, the structure was heated at a temperature of approximately 400° C. Thereafter, the inside of the device is evacuated to approximately 1 μPa through an exhaust pipe EXC and, thereafter, the exhaust pipe EXC is sealed.

In the above-mentioned embodiment, although the explanation has been made with respect to the structural example which uses the MIM-type electron source as the electron sources, the present invention is not limited to such an electron source and the present invention is applicable to the self-luminous planar display device which uses the above-mentioned various electron sources in the same manner.

What is claimed is:

1. A self-luminous planar display device comprising:
a back panel which forms a display region having a large number of pixels on a back substrate, the pixels including a large number of first electrodes which extend in a first direction and are arranged in parallel in a second direction which intersects the first direction, an interlayer insulation film which is formed to cover the first electrodes, a large number of second electrodes which extend in the second direction and are arranged in parallel in the first direction over the interlayer insulation film, and electron sources which are formed in a vicinity of intersecting portions between the first electrodes and the second electrodes;
a face panel which forms phosphor layers of plural colors which emit lights when excited by electrons taken out from the electron sources formed on the display region of the back panel and third electrodes on a face substrate; and
a sealing frame which is interposed between peripheral portions of the back panel and the face panel and seals both panels, wherein
at least one end of the first electrode includes a first electrode lead terminal which is pulled out to an outside from the display region through a sealing region where the back panel and the sealing frame face in an opposed manner,
at least one end of the second electrode includes a second electrode lead terminal which is pulled out to the outside from the display region through a sealing region where the back panel and the sealing frame face in an opposed manner, and
a bent portion for pulling out the lead terminal toward an exteriorly mounted drive circuit is formed on a portion of one of or both the first electrode lead terminal and the second electrode lead terminal in a vicinity of an inside of the sealing frame, and an exposed portion is formed on a surface of the interlayer insulation film or the back substrate by forming the bent portion, and
assuming a distance between the bent portion and the sealing frame as L1, a height of the sealing frame as H, and a distance between a periphery of the third electrode and the sealing frame as L2, a following relationship is established
12 mm≦(L1+H+L2)≦38 mm.

2. A self-luminous planar display device according to any one of claim 1, wherein one or a plurality of partition walls which holds a given distance between the back panel and the face panel are provided between the back panel and the face panel and inside the sealing frame.
